(19) United States
(12) Patent Application Publication
(10) Pub. No.: US 2021/0237157 A1
(43) Pub. Date: Aug. 5, 2021

(54) THREE-DIMENSIONAL PRINTING

(71) Applicant: Hewlett-Packard Development Company, L.P., Spring, TX (US)

(72) Inventors: Krzysztof Nauka, Palo Alto, CA (US); Vladek Kasperchik, Corvallis, OR (US); Mohammed S. Shaarawi, Corvallis, CA (US)

(73) Assignee: Hewlett-Packard Development Company, L.P., Spring, TX (US)

(21) Appl. No.: 17/047,521

(22) PCT Filed: Oct. 23, 2018
(86) PCT No.: PCT/US2018/056998

§ 371 Date: Oct. 14, 2020

(51) Int. Cl. B22F 10/14; C08K 3/11; B22F 1/00; B22F 3/10; B22F 12/43; B33Y 10/00; B33Y 30/00; B33Y 70/10

(52) U.S. Cl. CPC B22F 10/14; C08K 3/11; B22F 1/0011; B22F 3/1007; B22F 2304/10; B33Y 10/00; B33Y 30/00; B33Y 70/10; B22F 12/43

(57) ABSTRACT

A three-dimensional printing kit can include a binder fluid and a particulate build material. The particulate build material can include from about 80 wt % to 100 wt % metal particles that can have a D50 particle size distribution from about 1 μm to about 150 μm, wherein the metal particles of the particulate build material can include surface-irradiated metal particles, and wherein the particulate build material can exhibit a water contact angle from 0° to about 25°.

### BACKGROUND

Three-dimensional (3D) printing may be an additive printing process used to make three-dimensional solid parts from a digital model. Three-dimensional printing is often used in rapid product prototyping, mold generation, mold master generation, and short run manufacturing. Some 3D printing techniques are considered additive processes because they involve the application of successive layers of material. This is unlike other machining processes, which often rely upon the removal of material to create the final part. Some 3D printing methods use chemical binders or adhesives to bind build materials together. Other 3D printing methods involve partial sintering, melting, etc. of the build material. For some materials, partial melting may be accomplished using heat-assisted extrusion, and for some other materials curing or fusing may be accomplished using, for example, ultra-violet light or infrared light.

### BRIEF DESCRIPTION OF THE DRAWINGS

FIG. 1 graphically illustrates an example three-dimensional printing kit in accordance with the present disclosure;

FIG. 2 graphically illustrates irradiating metal particles with a non-coherent electromagnetic energy source in accordance with the present disclosure;

FIG. 3 graphically illustrates an example system for three-dimensional printing in use in accordance with the present disclosure; and

FIG. 4 is a flow diagram illustrating an example method of three-dimensional printing in accordance with the present disclosure.

### DETAILED DESCRIPTION

Three-dimensional (3D) printing can be an additive process that can involve the application of successive layers of particulate build material with chemical binders or adhesives printed thereon to bind the successive layers of the particulate build materials together. In some processes, application of binder can be utilized to form a green body object and then a fused three-dimensional physical object can be formed therefrom. More specifically, binder fluid can be selectively applied to a layer of a particulate build material on a support bed to pattern a selected region of the layer and then another layer of the particulate build material is applied thereon. The binder fluid can be applied to another layer of the particulate build material and these processes can be repeated to form a green part (also known as a 3D green body or object), which can then be heat fused to form a sintered 3D object.

In accordance with examples of the present disclosure, a pulsed, non-coherent electromagnetic energy source can be used to alter the surface characteristics of metal particles of a particulate build material. Metal particles can have surface energy variability due to surface contaminants, such as complex oxides, suboxides, metallic compounds, organic contaminants, low surface energy contaminants, i.e. hydrophobic organic contaminants, and so on. These contaminants can be introduced during fabrication, storage, handling, and/or in the case of recycled powders during earlier use. These surface contaminants can make the metal particles exhibit hydrophobicity and limit their ability to be wetted by aqueous binder fluids.

In accordance with the presence disclosure, irradiating individual build material layers including metal particles can increase the hydrophilicity of the metal particles. This increase can be due to volatilization and decomposition of surface contaminants and the elimination of organic and inorganic moieties from the surface of the metal particles. An increase in hydrophilicity can also permit the individual build material layer to absorb aqueous binder fluid and can provide the ability to print thereon without major structural defects and shape distortion. In addition, irradiating can allow recycled powders to be used in additive manufacturing processes; thereby, reducing the costs associated with powder based additive manufacturing processes.

In accordance with this, in one example, a three-dimensional printing kit can include a binder fluid; and a particulate build material that can include from about 80 wt % to 100 wt % metal particles that can have a D50 particle size distribution value from about 1 μm to about 150 μm, wherein the metal particles of the particulate build material can include surface-irradiated metal particles, wherein the particulate build material can exhibit a water contact angle from 0° to about 25°. In one example, the binder fluid can include water and a polymer binder or a polymerizable binder. In another example, the metal particles can have a D50 particle size distribution value from about 5 μm to about 100 μm. In a further example, the metal particles can include elemental metals or alloys of titanium, cobalt, chromium, nickel, vanadium, tungsten, tantalum, molybdenum, iron, stainless-steel, steel, or an admixture thereof.

In another example, a method of three-dimensional printing can include, iteratively applying individual build material layers of a particulate build material that can include metal particles present in an amount ranging from about 80 wt % to 100 wt %, wherein a layer thickness can be equal to or less than 150 μm, and wherein a plurality of the metal particles can include surface contaminants and the particulate build material can exhibit a water contact angle from about 60° to about 180°; iteratively irradiating the individual build material layers of the particulate build material with pulsed, non-coherent electromagnetic energy that can have a peak wavelength from about 390 nm to about 1,100 nm at a radiant energy density impinging upon a surface of an individual build material layer at from about 3 J/cm² to about 25 J/cm² to remove surface contaminants and to modify the water contact angle of the particulate build material to from 0° to about 25°; and based on the 3D object model, selectively applying a binder fluid to individual build material layers to define individually patterned layers that are built up and bound together to form a 3D green body object. In one example, the individual build material layers can have a thickness ranging from about 1 μm to about 100 μm. In another example, the metal particles can have a D50 particle size distribution value from about 1 μm to 150 μm. In yet another example, the iteratively irradiating the individual build material layers can involve flash heating the individual build material layers with a single pulse of the non-coherent electromagnetic energy at a radiant energy density that can uniformly impinge upon the irradiated surface at from about 10 J/cm² to about 25 J/cm². In a further example, the iteratively irradiating of the individual build material layers can involve flash heating the individual build material layers with from 2 to about 20 pulses of the non-coherent electromagnetic energy at a radiant energy density that can uniformly impinge upon the irradiated surface at from about 3 J/cm² to about 20 J/cm². In one example, the binder fluid can include water and a polymer binder or a polymerizable binder. In another example, the iteratively irradiating the individual build material layers can occur in an inert atmosphere that cannot be reactive with the particulate build material and the binder fluid. In a further example, the method can further include heat fusing the 3D green body object to sinter or anneal the metal particles together to form a sintered 3D object.

Further presented herein, in an example, is a system for three-dimensional printing. The system for three-dimensional printing can include, a particulate build material that can include about 80 wt % to 100 wt % metal particles that can have a D50 particle size distribution value from about 1 μm to about 150 μm; a build material applicator to distribute an about 1 μm to about 150 μm layer of the particulate build material onto a support bed; and a flash radiation source directed towards the support bed, the flash radiation source to emit 1 pulse to about 20 pulses of non-coherent electromagnetic energy that can have a wavelength from about 390 nm to about 1,100 nm at a radiant energy density of about 3 J/cm² to about 25 J/cm². In one another example, a plurality of the metal particles can include surface contaminants, the particulate build material can exhibit a water contact angle from about 60° to about 180° prior to exposure to the non-coherent electromagnetic energy, and the flash radiation source can be established at a setting so that the particulate build material can exhibit a water contact angle from 0° to about 25° after exposure to the non-coherent electromagnetic energy. In a yet another example, the system can further include a fluid ejector fluidly coupled or coupleable to a binder fluid that can include water and a polymer binder or a polymerizable binder.

It is noted that when discussing the three-dimensional printing kit, the method of three-dimensional printing, and/or the system for three-dimensional printing herein, these discussions can be considered applicable to one another whether or not they are explicitly discussed in the context of that example. Thus, for example, when discussing a metal particle related to a three-dimensional printing kit, such disclosure is also relevant to and directly supported in the context of the method of three-dimensional printing, the system for three-dimensional printing, and vice versa.

It is also understood that terms used herein will take on their ordinary meaning in the relevant technical field unless specified otherwise. In some instances, there are terms defined more specifically throughout the specification or included at the end of the present specification, and thus, these terms can have a meaning as described herein.

Three-Dimensional Printing Kits and Systems

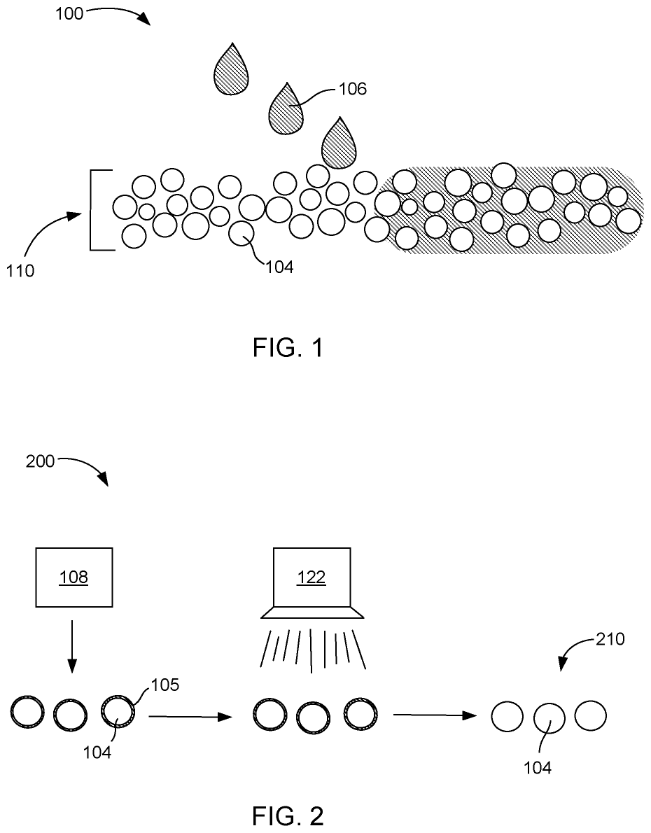

In accordance with examples of the present disclosure, a three-dimensional printing kit 100 is shown in FIG. 1. The three-dimensional printing kit can include a binder fluid 106, and a particulate build material 110 that can include, by way of example, from about 80 wt % to 100 wt % metal particles 104 which include surface-irradiated metal particles. Thus, with the surface-irradiated metal particles present, the particulate build material as a whole can exhibit a water contact angle from 0° to about 25°. The binder fluid, shown in FIG. 1 by example as droplets being applied to the particulate build material, may be packaged or co-packaged with the particulate build material in separate containers, and/or the particulate build material of the three-dimensional printing kit can be generated by irradiation just prior to application of the binder fluid, e.g., on the support bed or powder bed used in supporting the particulate build material during a build of a green body object or part.

As shown in FIG. 2, a flash radiation source 122 that emits pulsed, non-coherent electromagnetic energy is shown which can be used to decontaminate the surface 105 of metal particles 104, and thereby form the three-dimensional printing kits shown by way of example in FIG. 1. In this example, a layer of particulate build material that includes metal particles can be spread out or distributed on a substrate by a build material applicator 108, for example, and then as a thin layer, irradiated by the flash radiation source. By decontaminating the surfaces of the metal particles in this manner, as shown at 210, the surface energy of the surface of the metal particles can be positively modified for purposes of three-dimensional printing using the aqueous fluid binders described herein. As evidence for the surface energy modification, the water contact angle of a layer of the particulate build material (prior to applying binder) can exhibit more hydrophilic properties. In one example, the irradiating can result in metal particles of the particulate build material layer that can have a water surface contact angle from 0° to about 25°. In another example, the metal particles of the particulate build material layer that can have a water surface contact angle from about 5° to about 20° or from about 0° to about 15°. These contact angles can be compared to pre-irradiated water contact angles that may be from about 60° to about 180°, or in some examples from about 60° to about 180°. The hydrophilic properties facilitates better penetration of the binder fluid into the thin layer and thereby provides better particle binding.

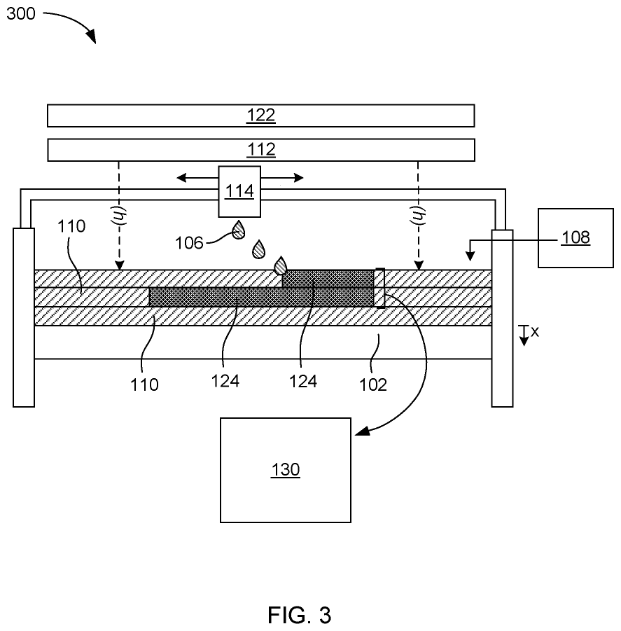

In FIG. 3, the three-dimensional printing kit shown at 100 in FIG. 1 can likewise be formed during the 3D printing process (rather than in advance). In this example, the particulate build material 110 can deposited from a build material applicator 108 onto a build platform 102 where it can be flattened or smoothed, such as by a mechanical roller or other flattening technique. At this point, the particulate build material can be irradiated as described with respect to FIG. 2. For example, during the 3D green body build process, to decontaminate the surface of the metal particles, individual build material layers can be irradiated by a flash radiation source 122. The irradiation can be, for example, pulsed, non-coherent electromagnetic energy having a peak wavelength from about 390 nm to about 1,100 nm at a radiant energy density impinging upon a surface of an individual build material layer at from about 3 J/cm² to about 25 J/cm² to remove surface contaminants and to modify the water contact angle of the particulate build material to from 0° to about 25°. When referring to a radiant energy density “impinging” on a surface of a build material layer, it is noted that the impingement of the radiant energy can be, in one example, uniform in application of radiant energy, or alternatively, even uniform in effect across the surface. For example, a differential in radiant energy density may be null across the surface, or may be within about 20% radiant energy density across the surface, or may have a uniform effect of decontamination across the surface being irradiated with pulsed energy. As a note, when applying radiant energy to decontaminate the build material layer particles, energy levels can be used that are sufficiently low so as to not disturb too much the binder that may be present in layers therebeneath that have already been printed so that the binder does not decompose sufficiently to cause the layer to be weakened too much (or at all in some instances). Using pulsed energy rather than more continuous energy can help ameliorate this issue

Once decontaminated, binder fluid 106 that may include water and a binder, such as a latex particle binder or another polymeric binder, for example, can be ejected onto the particulate build material from a fluid ejector 114, for example, to provide for selectively pattering the particulate build material. The location of the selective printing of the binder fluid can be to a layer corresponding to a layer of a 3D printed object, such as from a 3D object model or computer model. Heat (h) can be used, such as from a heat source 112, at the various layers (or group of layers, or after the 3D green body object is formed) to (i) facilitate the binder curing process, and/or (ii) remove solvent from the binder fluid, which can assist with more rapid solidification of individual layers. Removing solvent from the binder fluid can also reduce the wicking period of the binder fluid outside of the printed object boundary and allow for a more precise printed green part. In one example, heat can be applied from overhead, e.g., prior to application of the next layer of particulate build material, or after multiple layers are formed, etc., and/or can be provided by the build platform from beneath the particulate build material and/or from the particulate build material source (preheating particulate build material prior to dispensing on the build platform or previously applied 3D object layer). As metal can be very good conductors of heat, when applying heat from below, care can be taken to heat to levels that do not decompose the binder, in some examples. After individual layers are printed with binder fluid, the build platform can be dropped a distance of (x), which can correspond to the thickness of a printed layer in one example, so that another layer of the particulate build material can be added thereon and printed with the binder fluid, etc. The process can be repeated on a layer by layer basis until a green body is formed that is stable enough to move to an oven 130 suitable for fusing, e.g., sintering, annealing, melting, or the like. The green body in this example includes a 3D object formed from solidified green body object layers 124, which include both particulate build material and binder fluid that delivers the latex particles thereto.

Binder Fluid

In further detail, regarding the binder fluid that may be present in the three-dimensional printing kit or utilized in the three-dimensional printing method or the system for three-dimensional printing as described herein, any of a number of binders carried by a liquid vehicle for dispensing on the particulate build material can be used. The term “binder” can include material used to physically bind separate metal particles together or facilitate adhesion to a surface of adjacent metal particles to a green part or 3D green body object in preparation for subsequent sintering or annealing. The binder fluid can provide binding to the particulate build material upon application, or in some instances, can be further treated after printing to provide binding properties, e.g., exposure to IR energy to evaporate volatile species, exposure to flash heating (photo energy and heat) to activate a reducing agent, exposure to UV or IR energy to initiate polymerization, etc.

A “green” part or 3D green body object (or individual layer) refers to any component or mixture of components that is not yet sintered or annealed. Once the green part or 3D green body object is sintered or annealed, the part or body object can be referred to as a “brown” object or part. “Sintering” refers to the consolidation and physical bonding of the metal particles together (after temporary binding using the binder fluid) by solid state diffusion bonding, partial melting of metal particles, or a combination of solid state diffusion bonding and partial melting. The term “anneal” refers to a heating and cooling sequence that controls not the heating process, and the cooling process, e.g., slowing cooling in some instances, to remove internal stresses and/or toughen the sintered part or object (or “brown” part) prepared in accordance with examples of the present disclosure.

With more specific reference to the binder fluid that can be used, in one example, the binder fluid can include water and a polymer binder or a polymerizable binder. In one example, the polymer binder or polymerizable binder can be present at from about 2 wt % to about 30 wt %, from about 10 wt % to about 25 wt %, from about 3 wt % to about 20 wt %, from about 5 wt % to about 15 wt %, or from about 5 wt % to about 20 wt %.

The polymer binder or polymerizable binder can be a polymer that can have different morphologies. In one example, the polymer binder or polymerizable binder can include a uniform composition, e.g. a single monomer mixture, or can include two different compositions, e.g. multiple monomer compositions, copolymer compositions, or a combination thereof, which may be fully separated core-shell polymers, partially occluded mixtures, or intimately comingled as a polymer solution. In another example, the polymer binder or polymerizable binder can be individual spherical particles containing polymer compositions of hydrophilic (hard) component(s) and/or hydrophobic (soft) component(s). For example, a core-shell polymer can include a more hydrophilic shell with a a more hydrophic core or a more hydropobic shell with a more hydrophillic core. With respect to “more hydrophiliic” and “more hydrophobic” the term more is a relative term that indicates a hydrophillic or hydrophobic property when considering the core composition and the shell composition in respect to one another.

In some examples, the polymer binder or polymerizable binder can include latex particles. The latex particles can include 2, 3, or 4 or more relatively large polymer particles that can be attached to one another or can surround a smaller polymer core. In a further example, the latex particles can have a single phase morphology that can be partially occluded, can be multiple-lobed, or can include any combination of any of the morphologies disclosed herein. In some examples, the latex particles can be produced by emulsion polymerization. The latex particles in the binder fluid can include polymerized monomers of vinyl, vinyl chloride, vinylidene chloride, vinyl ester, functional vinyl monomers, acrylate, acrylic, acrylic acid, hydroxyethyl acrylate, methacrylate, methacrylic acid, styrene, substituted methyl styrenes, ethylene, maleate esters, fumarate esters, itaconate esters, α-methyl styrene, p-methyl styrene, methyl (meth)acrylate, hexyl acrylate, hexyl (meth)acrylate, butyl acrylate, butyl (meth)acrylate, ethyl acrylate, ethyl (meth)acrylate, propyl acrylate, propyl (meth)acrylate, 2-ethylhexyl acrylate, 2-ethylhexyl (meth)acrylate, isodecyl (meth) acrylate, octadecyl acrylate, octadecyl (meth)acrylate, stearyl (meth)acrylate, vinylbenzyl chloride, isobornyl acrylate, isobornyl (meth)acrylate, tetrahydrofurfuryl acrylate, tetrahydrofurfuryl (meth)acrylate, 2-phenoxyethyl (meth)acrylate, benzyl (meth)acrylate, benzyl acrylate, ethoxylated nonyl phenol (meth)acrylate, isobornyl (meth)acrylate, cyclohexyl (meth)acrylate, trimethyl cyclohexyl (meth)acrylate, t-butyl (meth)acrylate, n-octyl (meth)acrylate, lauryl (meth)acrylate, tridecyl (meth)acrylate, alkoxylated tetrahydrofurfuryl acrylate, alkoxylated tetrahydrofurfuryl (meth)acrylate, isodecyl acrylate, isobornyl methacrylate, isobornyl acrylate, dimethyl maleate, dioctyl maleate, acetoacetoxyethyl (meth)acrylate, diacetone acrylamide, diacetone (meth)acrylamide, N-vinyl imidazole, N-vinylcarbazole, N-vinyl-caprolactam, combinations thereof, derivatives thereof, or mixtures thereof. These monomers include low glass transition temperature (Tg) monomers that can be used to form the hydrophobic component of a heteropolymer.

In other examples, the latex particles can include acidic monomers that can be used to form the hydrophilic component of a heteropolymer. Example acidic monomers that can polymerized in forming the latex particles can include acrylic acid, methacrylic acid, ethacrylic acid, dimethylacrylic acid, maleic anhydride, maleic acid, vinylsulfonate, cyanoacrylic acid, vinylacetic acid, allylacetic acid, ethylidineacetic acid, propylidineacetic acid, crotonoic acid, fumaric acid, itaconic acid, sorbic acid, angelic acid, cinnamic acid, styrylacrylic acid, citraconic acid, glutaconic acid, aconitic acid, phenylacrylic acid, acryloxypropionic acid, aconitic acid, phenylacrylic acid, acryloxypropionic acid, vinylbenzoic acid, N-vinylsuccinamidic acid, mesaconic acid, methacroylalanine, acryloylhydroxyglycine, sulfoethyl methacrylic acid, sulfopropyl acrylic acid, styrene sulfonic acid, sulfoethylacrylic acid, 2-methacryloyloxymethane-1-sulfonic acid, 3-methacryoyloxypropane-1-sulfonic acid, 3-(vinyloxy)propane-1-sulfonic acid, ethylenesulfonic acid, vinyl sulfuric acid, 4-vinylphenyl sulfuric acid, ethylene phosphonic acid, vinyl phosphoric acid, vinyl benzoic acid, 2-acrylamido-2-methyl-1-propanesulfonic acid, sodium 1-allyloxy-2-hydroxypropane sulfonate, combinations thereof, derivatives thereof, or mixtures thereof. In some examples, the acidic monomer content can range from about 0.1 wt % to about 15 wt %, from about 0.5 wt % to about 12 wt %, or from about 1 wt % to about 10 wt % of the latex particles with the remainder of the latex particle being composed of non-acidic monomers. In some examples the acid monomer can be concentrated towards an outer surface of a latex particle.

The latex particles can have various molecular weights, sizes, glass transition temperatures, etc. In one example, the polymer in the latex particles can have a weight average molecular weight ranging from about 10,000 Mw to about 500,000 Mw, from about 100,000 Mw to about 500,000 Mw, or from about 150,000 Mw to about 300,000 Mw. The latex particles can have a particle size that can be jetted via thermal ejection or printing, piezoelectric ejection or printing, drop-on-demand ejection or printing, continuous ejection or printing, etc. In an example, the particle size of particles of the polymer binder or polymerizable binder can range from about 10 nm to about 400 nm. In yet other examples, a particle size of polymer binder or polymerizable binder can range from about 10 nm to about 300 nm, from about 50 nm to about 250 nm, from about 100 nm to about 300 nm, or from about 25 nm to about 250 nm. In some examples, the latex particle can have a glass transition temperature that can range from about range from about −20° C. to about 130° C., from about 60° C. to about 105° C., or from about 10° C. to about 110° C.

The latex polymer can be dispersed in a fluid suitable for jetting as a binder fluid. In one example, the binder fluid can include the latex polymer dispersed in an aqueous vehicle, such as a vehicle including water as a major solvent, e.g., the solvent present at the highest concentration compared to other co-solvents. Apart from water, the aqueous vehicle can include organic co-solvent(s), such as high-boiling solvents and/or humectants, e.g., aliphatic alcohols, aromatic alcohols, alkyl diols, glycol ethers, polyglycol ethers, 2-pyrrolidinones, caprolactams, formamides, acetamides, and long chain alcohols. Some other more specific example organic co-solvents that can be included in the binder fluid can include aliphatic alcohols, 1,2-alcohols, 1,3-alcohols, 1,5-alcohols, ethylene glycol alkyl ethers, propylene glycol alkyl ethers, higher homologs (C6-C12) of polyethylene glycol alkyl ethers, N-alkyl caprolactams, unsubstituted caprolactams, substituted formamides, unsubstituted formamides, substituted acetamides, unsubstituted acetamides, and combinations thereof. Some of water-soluble high-boiling solvents can act as coalescing aids for latex particles. Examples water-soluble high-boiling solvents can include propyleneglycol ethers, dipropyleneglycol monomethyl ether, dipropyleneglycol monopropyl ether, dipropyleneglycol monobutyl ether, tripropyleneglycol monomethyl ether, tripropyleneglycol monobutyl ether, dipropyleneglycol monophenyl ether, 2-pyrrolidinone and 2-methyl-1,3-propanediol. The organic co-solvent(s) in aggregate can comprise from 0 wt % to about 50 wt % of the binder fluid. In some examples, co-solvents can be present at from about 5 wt % to about 25 wt %, from about 2 wt % to about 20 wt %, or from about 10 wt % to about 30 wt % of the binder fluid.

The aqueous vehicle can be present in the binder fluid at from about 20 wt % to about 98 wt %, from about 70 wt % to about 98 wt %, from about 50 wt % to about 90 wt %, or from about 25 wt % to about 75 wt. In some examples, the binder fluid can further include from about 0.1 wt % to about 50 wt % of other liquid vehicle components. These liquid vehicle components can include other organic co-solvents, additives that inhibit growth of harmful microorganisms, viscosity modifiers, pH adjusters, sequestering agents, surfactants, preservatives, etc.

Some examples liquid vehicle components that can inhibit the growth of harmful microorganisms that can be present can include biocides, fungicides, and other microbial agents, which are routinely used in ink formulations. Commercially available examples can include ACTICIDE® (Thor GmbH), NUOSEPT® (Troy, Corp.), UCARCIDE™ (Dow), VANCIDE® (R.T. Vanderbilt Co.), PROXEL® (Arch Biocides), and combinations thereof.

With binder fluids, the polymer binder or polymerizable binder contained therein can undergo a pyrolysis or burnout process where the polymer essentially is removed during the sintering or annealing process. This can occur where the thermal energy applied to a green part or object removes inorganic or organic volatiles and/or other materials that may be present either by decomposition or by burning the binder fluid.

Particulate Build Material and Metal Particles

The particulate build material can include metal particles of any type that can be fused together at fusing temperature (above the temperature at which the green body is formed). Fusing can be carried out by sintering, annealing, melting, or the like, metal particles together within the particulate build material. In one example, the particulate build material can include from about 80 wt % to 100 wt % metal particles based on a total weight of the particulate build material.

In an example, the metal particles can be a single phase metallic material composed of one element. In this example, the fusing, e.g., sintering, annealing, etc., can occur at a temperature can be below the melting point of the element of the single phase metallic material. In other examples, the build material particles can be composed of two or more elements, which can be in the form of a single phase metallic alloy, e.g. the various particles can be alloys, or a multiple phase metallic alloy, e.g. different particles can include different metals. In these examples, fusing generally can occur over a range of temperatures. With respect to alloys, materials with a metal alloyed to a non-metal (such as a metal-metalloid alloy) can be used as well.

In some examples, the metal particles can include particles of elemental metals or alloys of titanium, cobalt, chromium, nickel, vanadium, tungsten, tantalum, molybdenum, iron, stainless steel, steel, or an admixture thereof. In one example, the metal particles can be stainless steel.

The D50 particle size of the metal particles can range from about 1 μm to equal to or less than about 150 μm. In some examples, the particles can have a D50 particle size distribution value that can range from about 10 μm to about 100 μm, from about 20 μm to about 150 μm, from about 15 μm to about 90 μm, or from about 50 μm to about 150 μm. Individual particle sizes can be outside of these ranges, as the “D50 particle size” is defined as the particle size at which half of the particles are larger than the D50 particle size and about half of the other particles are smaller than the D50 particle size (by weight based on the metal particle content of the particulate build material).

As used herein, particle size can refer to a value of the diameter of spherical particles or in particles that are not spherical can refer to a longest dimension of that particle. The particle size can be presented as a Gaussian distribution or a Gaussian-like distribution (or normal or normal-like distribution). Gaussian-like distributions are distribution curves that can appear Gaussian in their distribution curve shape, but which can be slightly skewed in one direction or the other (toward the smaller end or toward the larger end of the particle size distribution range). That being stated, an example Gaussian-like distribution of the metal particles can be characterized generally using “D10,” “D50,” and “D90” particle size distribution values, where D10 refers to the particle size at the 10^{th} percentile, D50 refers to the particle size at the 50^{th} percentile, and D90 refers to the particle size at the 90^{th} percentile. For example, a D50 value of 25 μm means that 50% of the particles (by number) have a particle size greater than 25 μm and 50% of the particles have a particle size less than 25 μm. Particle size distribution values are not necessarily related to Gaussian distribution curves, but in one example of the present disclosure, the metal particles can have a Gaussian distribution, or more typically a Gaussian-like distribution with offset peaks at about D50. In practice, true Gaussian distributions are not typically present, as some skewing can be present, but still, the Gaussian-like distribution can be considered to be “Gaussian” as used in practice. The shape of the particles of the particulate build material can be spherical, non-spherical, random shapes, or a combination thereof.

In some examples, the metal particles can include surface contaminants. These surface contaminants may include simple oxides, complex oxides, sub-oxides, metallic compounds, and/or organic contaminants. These contaminants can be introduced during manufacture of the metal particles, during subsequent storage of the metal particles, and/or on recycled metal particles during earlier use in three-dimensional printing processes. The surface contaminants can affect a surface energy and surface wetting property of the metal particles.

Surface contaminants can cause metal particles to have a lower surface energy and exhibit hydrophobic properties, i.e. exhibit low adhesion and less wettability by an aqueous binder fluid. Metal particles containing surface contaminants when arranged in a layer as a particulate build material can exhibit a water contact angle from about 60° to about 180°. “Water contact angle” as used herein, can be a measure of hydrophobicity of a layer of particulate build materials. Measuring water surface contact angles, can include measuring the water contact angle by a commercially available drop shape analyzer. Some example commercially available drop shape analyzers can include drop shape analyzers from Kruss (Kruss Optronic, Germany), Data Physics (Data Physics Corp., California), BIOLIN SCIENTIFIC® (Biolin Scientific AB, Denmark), and Apex Instruments (Apex Instruments, N. Carolina). The drop shape analyzer can deposit from about 1 microliters (μL) to about 1,000 μL water droplet on from about 500 μm to about 5 mm thick layer of the particulate build material. The drop shape analyzer can subsequently measure the water contact angle of the water droplet over time.

Three-Dimensional Printing Method

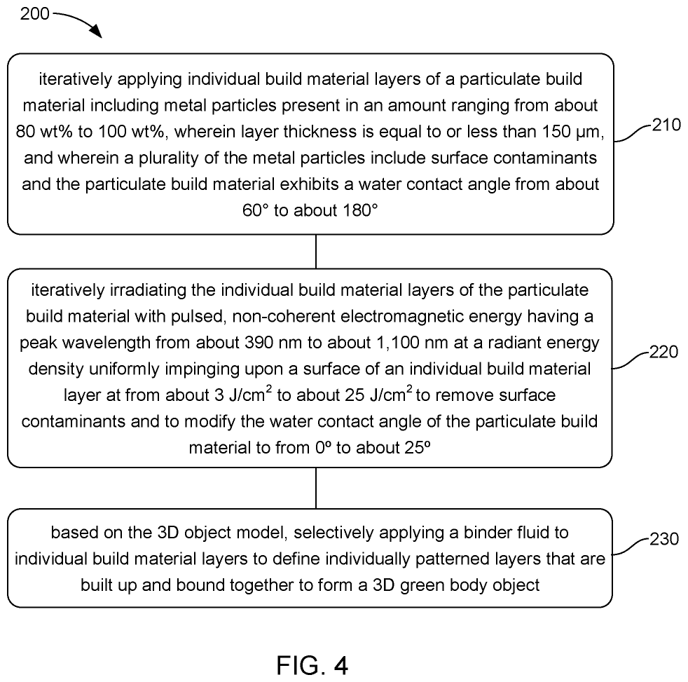

A flow diagram of an example method of three-dimensional (3D) printing 200 is shown in FIG. 4. The method can include iteratively applying 210 individual build material layers of a particulate build material including metal particles present in an amount ranging from about 80 wt % to 100 wt %, wherein a layer thickness is equal to or less than about 150 μm, and wherein a plurality of the metal particles can include surface contaminants and the particulate build material can exhibit a water contact angle from about 60° to about 180°. The method can also include iteratively irradiating 220 the individual build material layers of the particulate build material with pulsed, non-coherent electromagnetic energy that can have a peak wavelength from about 390 nm to about 1,100 nm at a radiant energy density that can uniformly impinge upon the irradiated surface at from about 3 J/cm² to about 25 J/cm² to remove surface contaminants and to modify the water contact angle of the particulate build material to from 0° to about 25°. Based on the 3D object model, the method can also include selectively 230 applying a binder fluid to individual build material layers to define individually patterned layers that can be built up and bound together to form a 3D green body object. The particulate build material including the metal particles (contaminated prior to irradiation) and binder fluid and related systems can be those described previously, for example.

In further detail, iteratively applying individual build material layers of the particulate build material can include applying individual build material layers at a thickness that can range from about 1 μm to about 150 μm, from about 20 μm to about 150 μm, from about 10 μm to about 100 μm, from about 25 μm to about 75 μm, from about 10 μm to about 50 μm, or from about 50 μm to about 125 μm. In some examples, the individual build material layer can have a thickness of from about 1 μm to about 100 μm.

The iteratively irradiating of the individual build materials with pulsed, non-coherent electromagnetic energy can include 1 to about 20 pulses of a non-coherent electromagnetic energy source onto the individual build material layer. In some examples, the irradiating can be a single pulse. In other examples, the irradiating can include about 5 pulses to about 10 pulses, from 2 pulses to about 5 pulses, from about 10 pulses to about 20 pulses, or from about 3 pulses to about 6 pulses. A time period between individual pulses of multiple pulsed irradiating can range from about 0.001 seconds to about 10 seconds.

The pulsed, non-coherent electromagnetic energy source can be a xenon discharge lamp or a pulsed laser. In one example, the pulsed, non-coherent electromagnetic energy source can be a xenon discharge lamp. The pulsed, non-coherent electromagnetic energy source can generate pulsed, non-coherent electromagnetic energy having a peak wavelength from about 390 nm to about 1,100 nm, from about 390 nm to about 800 nm, from about 390 nm to about 750 nm, or from about 400 nm to about 1,000 nm. The radiant energy can have a radiant energy density impinging upon the irradiated surface of the individual build materials layer from about 3 J/cm² to about 25 J/cm², from about 3 J/cm² to about 20 J/cm², from about 8 J/cm² to about 16 J/cm², from about 10 J/cm² to about 25 J/cm² or from about 15 J/cm² to about 20 J/cm². In some examples, the pulsed, non-coherent electromagnetic energy source can be combined with mirrors to reflect and uniformly irradiate an entire surface of the individual build material layer. In yet other examples, the irradiating can occur occurs in an inert atmosphere that cannot be reactive with the particulate build material and the binder fluid. For example, the inert atmosphere can contain from about 50 volume % to about 100 volume % of an inert gas. The inert gas can be selected from argon, nitrogen, neon, helium, krypton, xenon, carbon dioxide, or an admixture thereof.

Irradiating the individual build materials layers can remove surface contaminates from the metal particles of the particulate build material and can cause metal particles that exhibit hydrophobic properties to exhibit hydrophilic properties. In some examples, the irradiating can cause an individual build materials layer that can have a water contact angle from about 60° to about 180° prior to irradiation to have a water contact angle of from 0° to about 25° following irradiation. In other examples, the individual build materials layer can have a water contact angle of greater than 90°, greater than about 100°, or greater than about 120° prior to irradiation and can have a water contact angle of from 0° to about 25° following irradiation.

Following irradiation, the individual build materials layer can exhibit a greater affinity to the aqueous binder fluid. The aqueous binder fluid can penetrate spaces between individual particles of the particulate build material. The binder fluid can be selectively printed from a fluid ejector. In some examples, the fluid ejector can be a print head that can be a piezoelectric print head, a thermal inkjet print head, or a continuous inkjet print head. After an individual build material layer is printed with binder fluid, in some instances the individual build material layer can be heated to drive off water and to further solidify the layer of the 3D green body object. The build platform can be dropped a distance of (x), which can correspond to the thickness of a printed layer of the 3D green body object, so that another layer of the particulate build material can be added thereon, printed with binder fluid, solidified, etc. The process can be repeated on a layer by layer basis until the entire 3D green body object is formed that is stable enough to move to an oven suitable for fusing, e.g., sintering, annealing, melting, or the like.

In some examples, heat can be applied to the individual build material layers (or group of layers) with binder fluid printed thereon to drive off water from the binder fluid and to further solidify the individual build material layers of the 3D green body object. In one example, heat can be applied from overhead and/or can be provided by the build platform from beneath the particulate build material. In some examples, the particulate build material can be heated prior to dispensing. Further, the heating can occur upon application of the binder fluid to the individual build material layers or following application of all the printed binder fluid. The temperature(s) at which the metal particles of the particulate build material fuse together is/are above the temperature of the environment in which the patterning portion of the 3D printing method is performed, e.g., patterning at from about 18° C. to about 300° C. and fusing at from about 500° C. to about 3,500° C. In some examples, the metal particles of the particulate build material can have a melting point ranging from about 500° C. to about 3,500° C. In other examples, the metal particles of the particulate build material may be an alloy having a range of melting points.

Thus, following the formation of the 3D green body object, the entire 3D green body object can be moved to an oven and heated to a temperature ranging from about 500° C. to about 3,500° C., or more typically from about 600° C. to about 1,500° C. to fuse the metal particles together and to form a sintered 3D object. In some examples, the temperature can range from about 600° C. to about 1,200° C., from about 800° C. to about 1,200° C., or from about 750° C. to about 1,500° C. Depending on the metal particles, these temperature ranges can be used to melt an outer layer of the metal particles and can permit sintering of the metal particles to one another, while not melting an inner portion of the metal particles, in one example.

The eventual sintering temperature range can vary, depending on the material, but in one example, the sintering temperature can range from about 10° C. below the melting temperature of the metal particles of the particulate build material to about 50° C. below the melting temperature of the metal particles of the particulate build material. The sintering temperature can also depend upon the particle size and period of time that heating occurs, e.g., at a high temperature fora sufficient time to cause particle surfaces to become physically merged or composited together). For example, a sintering temperature for stainless steel can be about 1400° C. and an example of a sintering temperature for aluminum or aluminum alloys can range from about 550° C. to about 620° C. The sintering temperature can sinter and/or otherwise fuse the metal particles to form the sintered 3D object.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 10%, or, in one aspect within 5%, of a stated value or of a stated limit of a range. The term “about” when modifying a numerical range is also understood to include as one numerical subrange a range defined by the exact numerical value indicated, e.g., the range of about 1 wt % to about 5 wt % includes 1 wt % to 5 wt % as an explicitly supported sub-range.

As used herein, the phrase “green part,” “green body,” “3D green body object” and “layered green body” refers to any intermediate structure prior to any particle to particle material fusing, including a 3D green body object or object layer(s), a green 3D support structure or support structure layer(s), or an intermediate 3D breakaway interface or breakaway interface layer(s). As a green body, the particulate build material can be (weakly) bound together by a binder fluid. Typically, a mechanical strength of the green body is such that the green body can be handled or extracted from a build platform to place in a fusing oven. It is to be understood that any particulate build material that is not patterned with the binder fluid is not considered to be part of the green body, even if the particulate build material is adjacent to or surrounds the green body. For example, unprinted particulate build material can act to support the green body while contained therein, but the particulate build material is not part of the green body unless the particulate build material is printed with binder fluid, or some other fluid that is used to generate a solidified part prior to fusing, e.g., sintering, annealing, melting, etc.

As used herein, the terms “3D part,” “3D object,” or the like, refers to the target 3D object that is being built. The 3D object can be referred to as a “fused” or “sintered” 3D object, indicating that the object has been fused such as by sintering, annealing, melting, etc., or a “green body” or “green” 3D object, indicating the object has been solidified, but not fused.

“Binder fluid” refers to a fluid that includes water and binder particles that are effective for binding layers of particulate build material when forming a green body. The binder fluid is typically applied to form a 3D green body object.

The term “fluid” does not infer that the composition is free of particulate solids, but rather, can include solids dispersed therein, including carbon black pigment, latex particles, or other solids that are dispersed in the liquid vehicle of the fluid.

As used herein, “kit” can be synonymous with and understood to include a plurality of compositions including multiple components where the different compositions can be separately contained in the same or multiple containers prior to and during use, e.g., building a 3D object, but these components can be combined together during a build process. The containers can be any type of a vessel, box, or receptacle made of any material. Alternatively, a kit may be generated during the process of 3D building a portion at a time. For example, the particulate build material can be decontaminated a layer at a time to form a “kit” of a decontaminated (portion) or a particulate build material that, when combined with the binder fluid to be ejected thereon, completes the kit, e.g., a layer of decontaminated build material formed on a build platform or support bed is considered to be a kit when combined with a binder fluid loaded in a three-dimensional printing system for ejection thereon.

The term “fuse,” “fusing,” “fusion,” or the like refers to the joining of the material of adjacent particles of a particulate build material, such as by sintering, annealing, melting, or the like, and can include a complete fusing of adjacent particles into a common structure, e.g., melting together, or can include surface fusing where particles are not fully melted to a point of liquefaction, but which allow for individual particles of the particulate build material to become bound to one another, e.g., forming material bridges between particles at or near a point of contact.

As used herein, a plurality of items, structural elements, compositional elements, and/or materials may be presented in a common list for convenience. However, these lists should be construed as though the individual member of the list is identified as a separate and unique member. Thus, no individual member of such list should be construed as a de facto equivalent of any other member of the same list based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, as well as to include all the individual numerical values or sub-ranges encompassed within that range as the individual numerical value and/or sub-range is explicitly recited. For example, a weight ratio range of about 1 wt % to about 20 wt % should be interpreted to include the explicitly recited limits of 1 wt % and 20 wt % and to include individual weights such as about 2 wt %, about 11 wt %, about 14 wt %, and sub-ranges such as about 10 wt % to about 20 wt %, about 5 wt % to about 15 wt %, etc.

### EXAMPLES

The following illustrates an example of the present disclosure. However, it is to be understood that the following is illustrative of the application of the principles of the present disclosure. Numerous modifications and alternative compositions, methods, and systems may be devised without departing from the spirit and scope of the present disclosure. The appended claims are intended to cover such modifications and arrangements.

### Example 1—Irradiating Particulate Build Material Layers

Six different stainless steel particles (SS 316L) having a particle size distribution value ranging from 8 μm to 35 μm, as designated in Table 1, were spread in a 300 μm thick layer held at room temperature and evaluated for their water contact angle. The water contact angle was measured by depositing a 1 mL water droplet on each layer and the water contact angle was measured using a DS160 Drop Shape Analyzer available from Krüss Optronic, Germany. The measurement was taken 1 second after the water droplet was deposited on the layer.

TABLE 1
Stainless Steel Particles

| | | | | Water Contact |
|---|---|---|---|---|
| | | | Percent | Angle (measured |
| Particle | Powder | | Recycled | 1 sec after |
| Type (PT) | Type | Particle Size | Powder | droplet deposition |
| 1 | MIM | D90 < 25 um | | 160° |
| 2 | MIM | D90 < 25 um | | 170° |
| 3 | MIM | D90 < 22 um | | 30° |
| 4 | MIM | D90 < 25 um | 0% | 150° |
| 5 | MIM | D90 < 16 um | 0% | 0° |
| 6 | SLM | D50 = 35 um | 0% | 25° |

The hydrophobic nature of the layer of the stainless steel particles was further evidenced by the visible water droplet that remained on a surface of these layers over period of more than 10 seconds.

The individual layers held at room temperature were then placed in an inert atmosphere containing more than 95 volume % argon and irradiated with a single pulse (10 msec) of a high power xenon discharge lamp PulseForge 1300 from NovaCentrix having a wavelength of range of 300 nm to 1,100 nm and an energy density impinging on the respective surfaces of the metal particle layers at a pulse energy of 5.83 J/cm². After the pulse irradiation, layers were removed from the flash chamber and a water contact angle was then measured, as before. A subsequent layer of the metal particle-type was again spread and the process was repeated for one or a combination of the following pulse energies: 8.52 J/cm², 11.8 J/cm², 13.8 J/cm², 15.6 J/cm², 17.8 J/cm², and 20.1 J/cm², as indicated in the tables below.

TABLE 2
Water Contact Angle Following Irradiation

| Pulse | | Water Contact Angle* | | | | | |
|---|---|---|---|---|---|---|---|
| Energy | | PT 1 | PT2 | PT3 | PT4 | PT5 | PT6 |
| 5.83 | J/cm² | 160° | 160° | 30° | 150° | 0° | 25° |
| 8.52 | J/cm² | 160° | NT | 25° | 110° | 0° | 15° |
| 11.8 | J/cm² | 155° | NT | 25° | 90° | 0° | 12° |
| 13.8 | J/cm² | 0° | NT | 20° | 0° | 0° | 10° |
| 15.6 | J/cm² | 0° | 150° | 5° | 0° | 0° | 0° |
| 17.8 | J/cm² | 0° | NT | 0° | 0° | 0° | 0° |
| 20.1 | J/cm² | 0° | 0° | 0° | 0° | 0° | 0° |

*NT Designation indicates that this was not tested.

All of the metal particles that exhibited hydrophobic properties exhibited more hydrophilic properties following irradiation. Pulse irradiation with visible light caused rapid heating and cooling of the particles. The property change may have been a result of rapid heating, photochemical reactions, or a combination thereof. Particles that are hydrophilic to begin with do not change, as they are already hydrophilic.

What is claimed is:

1. A three-dimensional printing kit comprising:
a binder fluid; and
a particulate build material comprising about 80 wt % to 100 wt % metal particles having a D50 particle size distribution value from about 1 μm to about 150 μm, wherein the metal particles of the particulate build material include surface-irradiated metal particles, wherein the particulate build material exhibits a water contact angle from 0° to about 25°.

2. The three-dimensional printing kit of claim 1, wherein the binder fluid includes water and a polymer binder or a polymerizable binder.

3. The three-dimensional printing kit of claim 1 wherein the metal particles have a D50 particle size distribution value from about 5 μm to about 100 μm.

4. The three-dimensional printing kit of claim 1, wherein the metal particles include elemental metals or alloys of titanium, cobalt, chromium, nickel, vanadium, tungsten, tantalum, molybdenum, iron, stainless-steel, steel, or an admixture thereof.

5. A method of three-dimensional printing comprising:
iteratively applying individual build material layers of a particulate build material including metal particles present in an amount ranging from about 80 wt % to 100 wt %, wherein layer thickness is equal to or less than about 150 μm, and wherein a plurality of the metal particles include surface contaminants and the particulate build material exhibits a water contact angle from about 60° to about 180°;
iteratively irradiating the individual build material layers of the particulate build material with pulsed, non-coherent electromagnetic energy having a peak wavelength from about 390 nm to about 1,100 nm at a radiant energy density impinging upon a surface of an individual build material layer at from about 3 J/cm² to about 25 J/cm² to remove surface contaminants and to modify the water contact angle of the particulate build material to from 0° to about 25°; and
based on the 3D object model, selectively applying a binder fluid to individual build material layers to define individually patterned layers that are built up and bound together to form a 3D green body object.

6. The method of three-dimensional printing of claim 5, wherein the individual build material layers have a thickness ranging from about 1 μm to about 100 μm.

7. The method of three-dimensional printing of claim 5, wherein the metal particles have a D50 particle size distribution value from about 1 μm to about 150 μm.

8. The method of three-dimensional printing of claim 5, wherein iteratively irradiating the individual build material layers includes flash heating the individual build material layers with a single pulse of the non-coherent electromagnetic energy at a radiant energy density impinging upon the irradiated surface at from about 10 J/cm² to about 25 J/cm².

9. The method of three-dimensional printing of claim 5, wherein iteratively irradiating the individual build material layers involves flash heating the individual build material layers with from 2 pulses to about 20 pulses of the non-coherent electromagnetic energy at a radiant energy density impinging upon the irradiated surface at from about 3 J/cm² to about 20 J/cm².

10. The method of three-dimensional printing of claim 5, wherein the binder fluid includes water and a polymer binder or a polymerizable binder.

11. The method of three-dimensional printing of claim 5, wherein iteratively irradiating the individual build material layers occurs in an inert atmosphere that is not reactive with the particulate build material and the binder fluid.

12. The method of three-dimensional printing of claim 5, further comprising heat fusing the 3D green body object to sinter or anneal the metal particles together to form a sintered 3D object.

13. A system for three-dimensional printing comprising:
a particulate build material comprising about 80 wt % to 100 wt % metal particles having a D50 particle size distribution value from about 1 μm to about 150 μm;
a build material applicator to distribute an about 1 μm to about 150 μm layer of the particulate build material onto a support bed; and
a flash radiation source directed towards the support bed, the flash radiation source to emit about 1 pulse to about 20 pulses of non-coherent electromagnetic energy having a wavelength from about 390 nm to about 1,100 nm at a radiant energy density of about 3 J/cm² to about 25 J/cm².

14. The system for three-dimensional printing of claim 13, wherein a plurality of the metal particles include surface contaminants, the particulate build material exhibits a water contact angle from about 60° to about 180° prior to exposure to the non-coherent electromagnetic energy, and the flash radiation source is established at a setting so that the particulate build material exhibits a water contact angle from 0° to about 25° after exposure to the non-coherent electromagnetic energy.

15. The system for three-dimensional printing of claim 13, further comprising a fluid ejector fluidly coupled or coupleable to a binder fluid including water and a polymer binder or a polymerizable binder.
